(19) United States
(12) Patent Application Publication
(10) Pub. No.: US 2009/0070983 A1
(43) Pub. Date: Mar. 19, 2009

(54) SELF-PIERCING ELEMENT

(76) Inventors: Michael Stumpf, Bielefeld (DE); Andreas Marxkors, Hovelhof (DE); Stephan Bachmeier, Bielefeld (DE); Christoph Pekal, Krefeld (DE); Jorg Simon, Monchengladbach (DE); Matthias Langer, Waidhaus (DE)

Correspondence Address: SEYFARTH SHAW LLP, 131 S. DEARBORN ST., SUITE 2400, CHICAGO, IL, 60603-5803, US

(21) Appl. No.: 12/212,278

(22) Filed: Sep. 17, 2008

(30) Foreign Application Priority Data
Sep. 19, 2007 (DE) 10 2007 044 635.9

(51) Int. Cl. B23P 11/00; F16B 13/06

(52) U.S. Cl. 29/432; 29/243.54; 411/44

(57) ABSTRACT

The present invention discloses a self-piercing element, that can be fastened to a structural component by means of piercing and beading. Additionally, the present invention discloses an apparatus for seating the self-piercing element and a corresponding method. The self-piercing element comprises a functional head, a seat geometry and a cutting geometry, while the cutting geometry has a radially outwards arranged, centering exterior bevel, a radially inward arranged interior bevel and a cutting edge arranged in between.

### FIELD OF THE INVENTION

The present invention relates to a self-piercing element, which can be connected by means of piercing and beading to a structural component, preferably to a structural component composed of plastic in motor vehicle manufacturing. In addition, the present invention relates to a structural component, in which such a self-piercing element is fastened, an apparatus for inserting such a self-piercing element, and a method for fastening, with which such a self-piercing element can be fastened in the structural component.

### BACKGROUND OF THE INVENTION

In manufacturing motor vehicles, large-area structural components are attached, for example, as a splash guard in the underbody area and in the front end area of the vehicle. These structural components, which are also used in other areas of the motor vehicle, are composed of different plastics, with or without fiber reinforcement. The materials, for example, are SCT, GMT, CFRP, PP long fiber or similar. These structural components are, on the one hand, bound to frame structures of the motor vehicle. On the other hand, they serve as connection points for further mounting of components in the motor vehicle.

Such connecting points are formed by threaded elements or bore reinforcing elements, to name a few. This selection of connecting points is necessary because the plastic structural components have only a low strength, and furthermore, tend towards relaxation during mechanical loading. After structural components are manufactured, these threaded elements or bore reinforcing elements are subsequently inserted by various methods, and possibly clinched.

A further alternative consists in fastening elements, which provide the connecting points, in seat geometries pierced ahead of time. Generally, the holes and cut-outs for fastening of the connecting points are created by punch operations. In this context, it is necessary to reliably remove all stamped-out blanks. On the one hand, this guarantees that, for example, threaded inserts can be installed into the connecting points without problems. On the other hand, the removal of stamped-out blanks enables the use of a tool for finishing the plastic components, for instance, trimming the edges. Boring or milling of seat geometries are further alternatives. However, non-rounded geometries can be realized with these only to limited degree. In addition, these methods require a suitable possibility for removing the shavings that arise during processing.

The necessary torsional strength of the connection points and the threaded elements is in general guaranteed by a polygonal seat geometry, that is, by a polygonal cross-section seat geometry in the element, as well as in the plastic structural component. The non-round pre-punched hole of the structural component requires a rotational positioning of the element relative to the structural component. However, this torque-proof positioning requires additional expenditure during shaping of the element, as well as during the process of attaching the element in the structural component. At the same time, this additional expenditure is associated with an increased susceptibility to failure in the manufacturing process in comparison to simpler methods.

The use of self-punching elements is known, for example, from DE 37 44 450 C2 and JP 2002093489 A. Such self-punching elements avoid the additional expenditure of a second work step after creating the hole, to suitably position a component to be fastened, in order to insert the round or non-round metal insert in a second work step. However, for this purpose, a cutting geometry must be provided on the self-punching element. Thus, the self-punching element represents its own tool. In addition, it is necessary to provide a reliable removal of punch waste or shavings, in order to guarantee a reliable connection between the self-punching element and the structural component.

A further construction of self-punching fasteners is described in DE 20 2005 015 713 U1. These self-punching fasteners or elements are connected to a thin walled plastic part by punching and beading. The cutting edge of the self-punching element punches through or pierces during placement of the plastic part, and is subsequently deformed such that the element is fastened in the plastic part. In order to guarantee the necessary torque-proof fixing of the self-punching element, for example, a threaded element, it is equipped with a non-round—generally polygonal—seat geometry. For cost reasons, the cutting geometry at the element as well as the corresponding die are usually supplied round, whereby particularly in full production run, the incompletely severed material connections between the hole waste pieces and the plastic part leads to an increased susceptibility to failure.

Due to the low ductile deformability of plastics, in particular, fiber reinforced plastics, an embossing of the plastic into the undercuts formed by punching nuts is not possible. This excludes the use of known methods and constructions with placement of elements in metal components. Therefore, a secure seating of the self-punching element is only attainable by clinching the cutting geometry, which must be large enough to not exceed the permissible surface pressure of the screwed on component.

Therefore, in comparison to the known state of the art, the objective of the present invention is to provide a self-piercing element that can be reliably and easily fastened in structural components, preferably of plastic, by means of piercing and beading. In this context a further objective of the present invention is to deliver a suitable apparatus and a corresponding method for fastening this self-piercing element.

### SUMMARY OF THE INVENTION

The objectives above are solved by a self-piercing element according to independent patent Claim 1, by a structural component with this self-piercing element according to independent patent Claim 17, by an apparatus for setting a self-piercing element according to independent patent Claim 18, and by a setting method for a self-piercing element in a structural component according to independent patent Claim 22. Advantageous embodiments of the present invention arise from the dependent claims, the following description and the accompanying drawings.

The self-piercing element that can be connected to a structural component, preferably of plastic, by means of piercing and beading has the following features: a functional head arranged at one end of the element and coaxially to the longitudinal axis of the element, a cutting geometry arranged coaxially to the longitudinal axis of the element, and a seat geometry arranged between the functional head and the cutting geometry, while the cutting geometry includes a centering exterior bevel arranged radially outward, an interior bevel arranged radially inward, and a cutting edge arranged in between.

The self-piercing element according to the invention allows the insertion and anchoring of an element in the axial and rotational direction. The self-piercing element is inserted preferably into large-surface plastic structural components composed of duroplastic or thermoplastic material, with or without fiber reinforcement of glass or carbon fibers, with a one-layer or multilayered composition, and without the necessity of holes being created ahead of time. For the universal application of the self-piercing element, it has, for example, an inner thread, an outer functional contour or a through hole, in order to provide different fastening alternatives or the various connection points, for example, in the motor vehicle.

According to a preferred embodiment, the cutting edge has a width of 0.15±0.1 mm. In addition, it is conceivable that the exterior bevel extends over a length of 0.1 to 0.2 mm from the cutting edge, and is arranged at an angle of 10° to the longitudinal axis of the self-piercing element. To be able to adapt the self-piercing element to a resulting ring-shaped contact between element and structural component and/or to a permissible surface pressure of the structural component, the cutting geometry is definable in its length. In this context, it is preferred that the cutting edge of the self-piercing element runs along an outer surface of an imaginary cylinder, whose cylinder longitudinal axis is arranged perpendicularly to the longitudinal axis of the self-piercing element, such that a section of the cutting edge is shifted relative to the remaining cutting edge in the direction of the longitudinal axis of the self-piercing element. This design of the cutting geometry guarantees a self centering, drawing punch or cutting process by the self-piercing element.

In a further embodiment of the self-piercing element, its interior bevel is arranged at an angle of ≦45° to the longitudinal axis of the self-piercing element. Furthermore, it is preferred to provide the interior bevel in an angular range of 30° to 40°. In another embodiment of the self-piercing element, the interior bevel is arranged at an angle of ≧60°, preferably in an angular range of 70° to 85°, to the longitudinal axis of the self-piercing element. The production of this design of the self-piercing element is cost-effective compared to known alternatives. Furthermore, this design supports seating the self-piercing element in hard materials, for instance CFRP, and seating with low protrusion of the self-piercing element, such that a beading, for instance of protrusion is not necessary. According to a further design, the self-piercing element includes a second exterior bevel that is arranged radially outwards from the centering exterior bevel arranged at the outside.

To support the hold of the self-piercing element, according to an alternative, its seat geometry includes on its radial exterior a supporting holding structure and/or a seat area shifted radially inward. These holding structures act, for instance, as an undercut in the direction of the longitudinal axis and/or in the rotational direction about the longitudinal axis of the self-piercing element, depending on the arrangement of the holding structure.

According to a further preferred embodiment of the self-piercing element, its seat geometry is segmented into a first and second seat area, where the second seat area can be enlarged conically for fastening the self-piercing element. In addition, the first and second seat area are dimensionally adjusted to the structural component such that the first seat area extends over 30% and the second seat area extends over 70% of the thickness of the structural component at the joint location of the self-piercing element.

To further improve the hold of the self-piercing element in plastics, preferably in ductile deformable plastics, the functional head includes on its side facing the cutting geometry, a projecting contour beneath the head that supports a defined contact of the self-piercing element on the structural component. This can be optionally supplemented by a groove beneath the head, into which a material build-up can be received during seating of the self-piercing element, in order to support a seating of the functional head on the structural component.

The apparatus according to the invention for setting the self-piercing element in a structural component has the following features: a punching tool and a clinch tool, that are arranged opposing, and are movable parallel to their longitudinal axis in the joining direction, a die built from at least two segments arranged movably that defines an opening for the punching tool with the self-piercing element, while a position of the die segments can be adjusted such that a gap between the inside of the opening and the outside of the self-piercing element can be modified in its width depending on the material of the structural component and/or the conditions of the seating process, in order to optimally fasten the self-piercing element.

In a further embodiment of the apparatus, the clinch tool includes a clinch contour, adapted to a cutting geometry of the self-piercing element, with which the cutting geometry can be deformed radially outwards. In addition, it is preferable to equip the die of the apparatus on its side facing the punching tool, near the opening, with a contour running radially and projecting, with which a depression can be generated in the structural component.

The seating or setting method according to the invention for the self-piercing element in the structural component, using the apparatus described above, has the following steps: Positioning the self-piercing element with cutting geometry on the punching tool, positioning the structural component on the die and cutting the center waste piece from the structural component by advancing the punching tool to the structural component and lateral shifting of the segments of the die from the self-piercing element, and deforming of the cutting geometry of the self-piercing element by advancing the clinch tool to the structural component.

For a further design of the seating/setting method, it is preferred to position the segments of the die such that a gap between the inside of the opening and the outside of the self-piercing element is modified in its width depending on the material of the structural component and/or the conditions of the seating/setting process, in order to optimally fasten the self-piercing element.

In addition, the structural component of plastic is preferably heated at least in the area of the seating location of the self-piercing element, or the structural component is conveyed to the apparatus preferably before cooling completely, in order to facilitate seating/setting of the self-piercing element.

### BRIEF DESCRIPTION OF THE DRAWINGS

The present invention is explained in more detail referring to the accompanying drawings.

FIG. 1A-C show different embodiments of the self-piercing element,

FIG. 2A-C, 3 show different embodiments of the self-piercing element fastened in a structural component,

FIG. 4 shows a further embodiment of the self-piercing element,

FIG. 5 shows the self-piercing element from FIG. 4 in the fastened state in a structural component,

FIG. 6 shows a further embodiment of a self-piercing element,

FIG. 7 shows the self-piercing element from FIG. 6 in the fastened state in a structural component,

FIG. 8 shows the illustration of a specific feature of an embodiment of a self-piercing element,

FIG. 9 shows a sectional representation of the self-piercing element from FIG. 8,

FIG. 10 shows a sectional enlargement of the self-piercing element from FIG. 9,

FIG. 11 shows a detailed view of an embodiment of the self-piercing element during seating in a structural component,

FIG. 12 to 15 show a preferred embodiment of an apparatus for seating a self-piercing element in various states of the seating method,

FIG. 16 shows a schematic representation of the seating method of the self-piercing element

FIG. 17 shows a sectional representation of an embodiment of the die segments

FIG. 18 shows a flow diagram concerning an embodiment of the seating method of the self-piercing element

FIG. 19 shows a sectional representation of a further embodiment of the self-piercing element,

FIG. 20 shows a detail enlargement of the region labeled X in FIG. 19,

FIG. 21, 22 show a sectional representation of a further embodiment of the self-piercing element, and

FIG. 23 shows the self-piercing element from FIG. 22 in the seated state.

### DETAILED DESCRIPTION OF THE PREFERRED EMBODIMENTS OF THE INVENTION

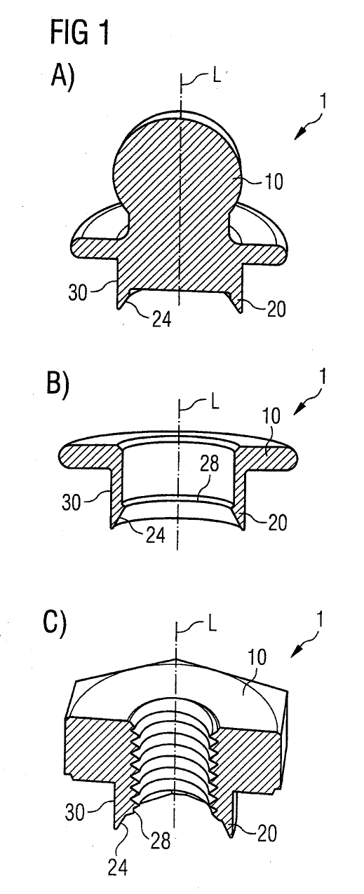

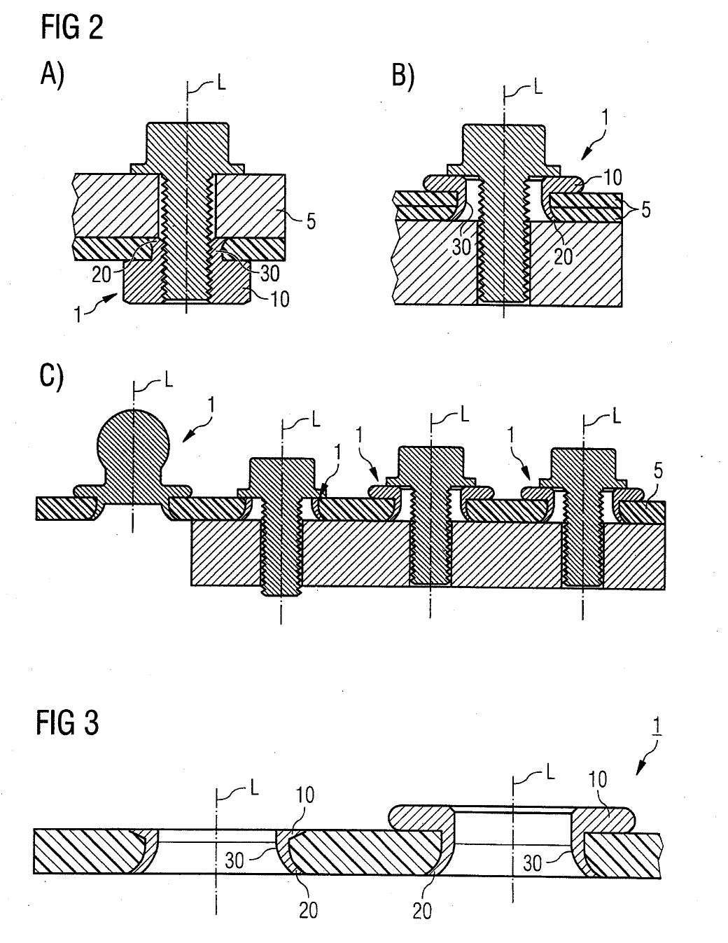

The FIGS. 1A-C show different embodiments of the self-piercing element 1. Relative to its longitudinal axis L, the self-piercing element 1 includes a functional head 10 at one end coaxial to its longitudinal axis L. This functional head 10 is formed differently depending on the function to be realized at the structural component 5. According to one alternative, the functional head 10 is composed of a spherical head according to FIG. 1A. This serves, for example, the attachment of a snap connection. According to a further alternative, the functional head 10 forms a supporting flange, as shown in FIG. 1C. The self-piercing element from FIG. 1C serves as a hole reinforcement in order to fasten the structural component 5 to a frame structure, for example, by means of screws. According to the construction shown in FIG. 1B, the functional head 10 is supported on the structural component 5. FIG. 1C shows a further alternative, in which the functional head 10 includes a threaded element. As can be seen in FIGS. 2C and 3, the functional head 10 is also formed in a countersunk structure. During the fastening of the self-piercing element 1 in the structural component 5, the functional head 10 is countersunk into the surface of the structural component 5, in order to end flush with it.

In addition, the self-piercing element 1 includes a cutting geometry 20 arranged coaxially to the longitudinal axis L of the element, and a seat geometry 30 arranged between the functional head 10 and the cutting geometry 20. The cutting geometry 20 includes a interior bevel 24 that is located radially inward. A support edge 28 is also arranged radially inward, with which a cut-out waste piece 3 (see below) can be caught, and a jamming of the waste piece 3 in the self-piercing element 1 can be prevented.

Self-piercing elements 1 fastened in the structural component 5 are shown in FIGS. 2, 3, 5 and 7. The large surface structural components 5 serve, for example, as a splash guard on the underbody or in the front end area of a motor vehicle. Preferably, the structural components 5 are composed of brittle, non-ductile and/or fiber reinforced plastic, for example, duroplastic or thermoplastic materials. These can be equipped with or without fiber reinforcements composed of glass or carbon fibers. In this context, SCT, GMT, CFRP, PP long fiber or similar are mentioned as example materials. In addition, the structural component 5 is preferably built in one layer or multilayered. Using the self-piercing element 1 according to the invention, the possibility now arises to equip the multitude of conceivable structural components 5 with such self-piercing elements 1 without the need for a pre-made punched hole.

As can be seen in FIGS. 2 and 3, the functional head 10 is supported on one side of the structural component 5. Preferably, the functional head 10 contacts the surface of the structural component 5 with its complete surface. According to a further alternative, it is also conceivable that it contacts the structural component 5 only with a support contour 12 (compare FIG. 4, 5).

The cutting geometry 20 and the seat geometry 30 anchor the self-piercing element 1 in the structural component 5. This anchoring acts against a displacement of the self-piercing element 1 in the direction of the longitudinal axis L of the self-piercing element 1. In addition, this anchoring acts against a rotation of the self-piercing element 1 about its longitudinal axis L. To support this type of anchoring of the self-piercing element 1, the cutting geometry 20, in the top view, has a round, oval, elliptical or polygonal shape. It is understood that the different constructive features of the self-piercing element 1 explained so far, and in the following, can be combined together in any manner, even if only selected combinations are shown in the illustrated embodiments.

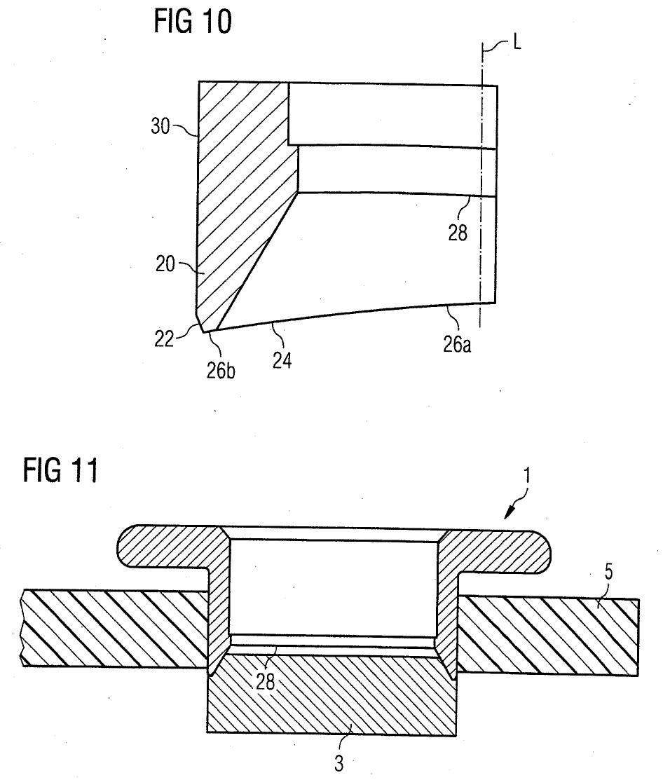

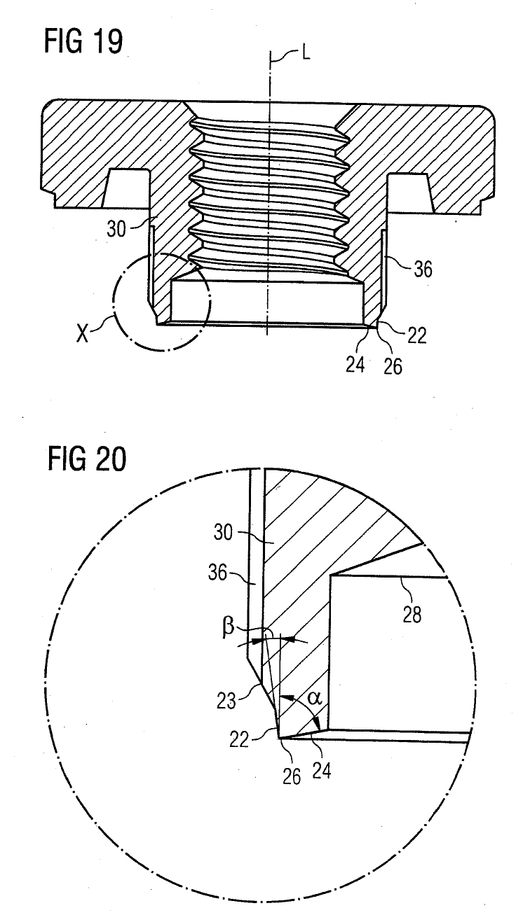

The cutting geometry 20 of the self-piercing element 1 is detailed in FIGS. 9 and 10, and is represented according to a further embodiment in FIGS. 19 and 20. In general, the cutting geometry 20 is formed either round or polygonal in cross-section. It includes the interior bevel 24, already mentioned above, that is located radially inward with respect to the longitudinal axis L. During seating of the self-piercing element 1, the interior bevel 24 forms a ring-shaped contact with the structural component 5. The area of the inner bevel 24 must be adjusted so that the maximally permissible surface pressure with respect to the material of the structural component 5 is not exceeded. This can be adjusted via the axial extent of the interior bevel 24, as well as over its circumferential length.

In addition, the cutting geometry 20 includes an exterior bevel 22 arranged radially outward. The exterior bevel 22 serves as a centering preceding the seat geometry 30, in order to prevent a tilting of the self-piercing element 1 during the seating process. Preferably, the exterior bevel 22 extends parallel to the longitudinal axis L over a length of 0.1 to 0.2 mm at an angle of 10° relative to the longitudinal axis L.

A cutting edge 26 is arranged between the interior bevel 24 and the exterior bevel 22. The cutting edge 26 guarantees the seating of the self-piercing element 1 in the structural component 5 without pre-punched holes. According to a preferred embodiment, the cutting edge 26 is 0.15±0.1 mm wide.

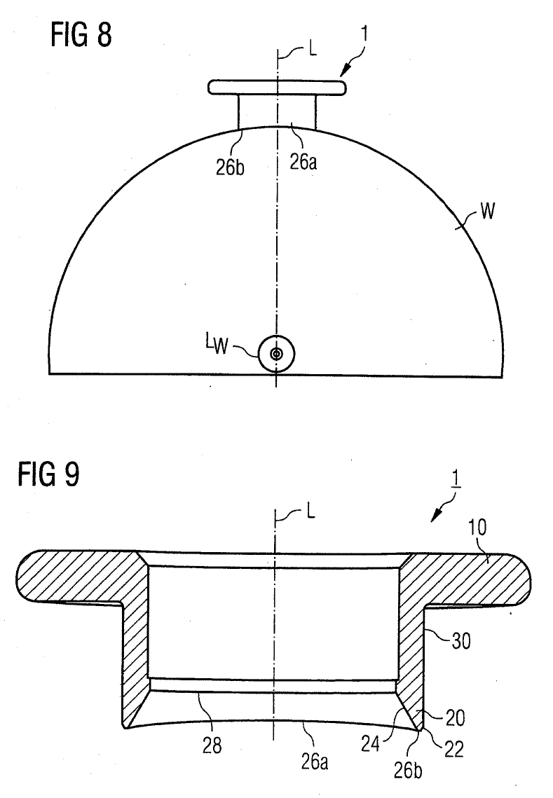

According to a further preferred design, the cutting edge 26 is formed as a receding cutting edge 26a, b (see FIGS. 8 to 10). The receding cutting edge 26a,b is formed such that it runs along the outer surface of an imaginary cylinder W (see FIG. 8). The longitudinal axis L_{W} of the cylinder W is arranged perpendicularly to the longitudinal axis L of the self-piercing element 1. From this, it follows that a section 26a of the cutting edge 26 is arranged offset from the remaining section 26b of the cutting edge 26 in the direction of the longitudinal axis L. Specifically, the cutting edge 26a recedes in the direction of the seat geometry 30. Based on this construction, a centering self-pulling punch or piercing process of the self-piercing element 1 arises during the seating. In addition, the cutting edge 26 can be adapted in its length to the material of the structural component 5 by a suitable selection of a diameter of the cylinder W, in order to obtain optimal results during seating of the self-piercing element 1.

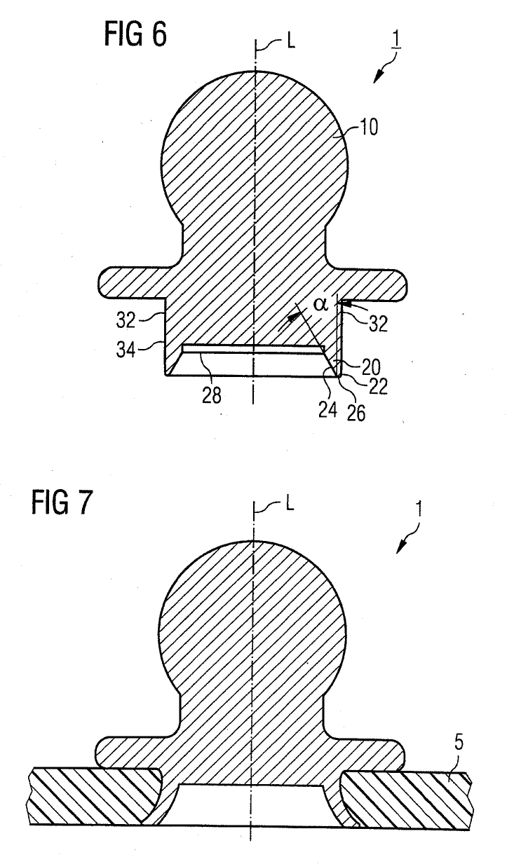

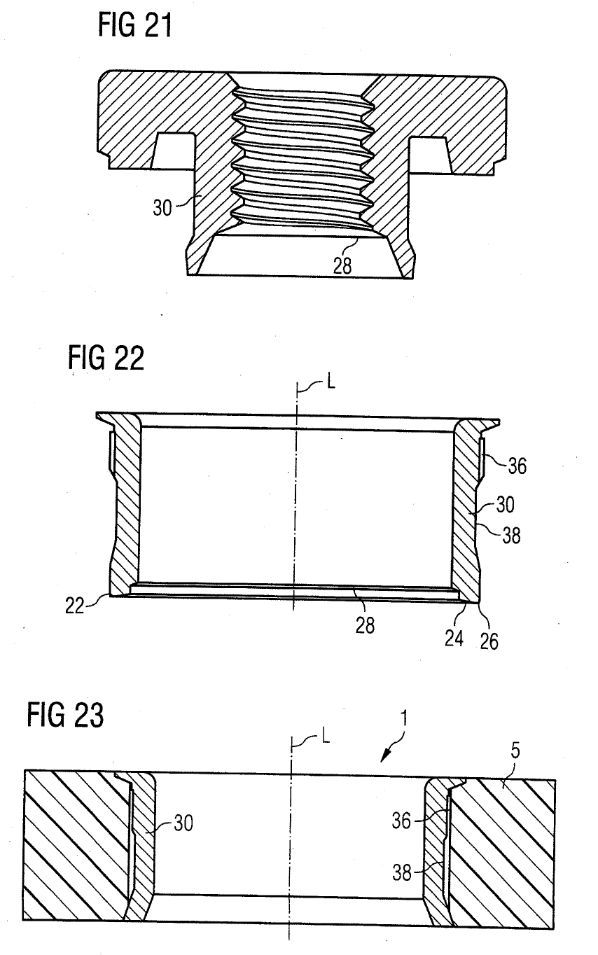

A further design of the cutting geometry is represented in the FIGS. 19 to 23. In FIG. 19, a preferred embodiment of the self-piercing element 1 is represented, while FIG. 20 represents an enlargement of the circled area in FIG. 19. It can be seen that the cutting geometry also includes the exterior bevel 22, the cutting edge 26 and the interior bevel 24. In the embodiments of FIGS. 1 to 11, the interior bevel 24 is arranged at an angle α≦45° with respect to the longitudinal axis of the self-piercing element 1 (see FIG. 6). Further, in this context, an angle range of 30° to 40° is preferred because with decreasing angles of α, the expansion or the beading during the seating process of the self-piercing element 1 is facilitated.

In the embodiments of FIGS. 19 to 22, the interior bevel 24 is arranged at an angle α≧60°, preferably in an angular range of 70°≦α≦85° to the longitudinal axis L of the self-piercing element 1. The exterior bevel 22 encloses an angle β of 0° to 30° with the longitudinal axis L of the self-piercing element 1. The cutting edge 26 is arranged between the interior bevel 24 and the exterior bevel 22. This construction of the cutting geometry is particularly suited for seating of the self-piercing element 1 into hard plastic, such as CFRP. The exterior bevel 22 is optionally supplemented by a further exterior bevel 23, arranged radially outward from the exterior bevel 22. This bevel also supports the seating of the self-piercing element 1. In addition, it is used with self-piercing elements 1, that show a small protrusion after the seating in the structural component 5. This is the case, for example, for structural components 5 with low thickness variations, such that the length of the self-piercing element 1 can be better adapted to the thickness of the structural component 5. In comparison to this, the construction of the self-piercing elements 1 of FIGS. 1 to 11 is suited, in particular, for soft plastics or when the self-piercing element 1 is inserted into structural components 5 that are still soft after the original forming. Preferred materials are polypropylene (PP) or glass mat reinforced thermoplastics (GMT) in a press-heated state at a temperature of ≧50° C.

In addition, the self-piercing elements 1 of FIGS. 1 to 11 are suited for compensating thickness variations in the structural component 5. The self-piercing elements 1 are used with these thickness variations with differently sized length protrusions on the structural component 5. However, these length protrusions can be suitably beaded in the seating process, such that they contribute to the fastening and the holding of self-piercing element 1, and also do not negatively impact the quality of the structural component 5 with self-piercing element 1.

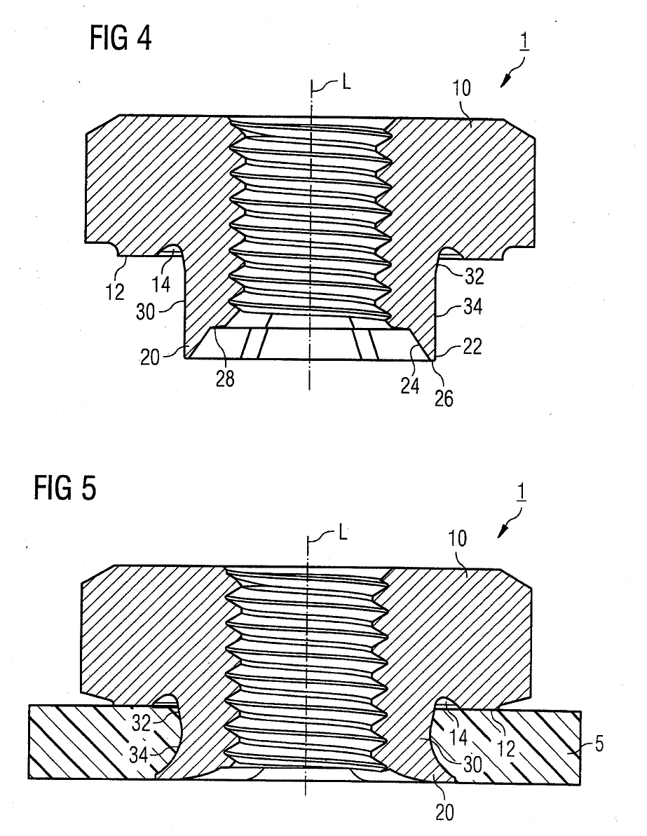

As arises from FIGS. 4 and 5, the seat geometry 30 is divided into a first 32 and second seat area 34. The seat geometry 30 is preferably formed rounded according to FIG. 6 or polygonal, as shown in FIG. 4. In addition, also its cross-section is circular shaped, oval, elliptical or polygonal. In this context, an embodiment consists in that the first seat area 32 is formed conically in the axial direction. The first seat area 32 runs at an angle of 5±0.5° relative to the longitudinal axis L of the self-piercing element 1. In the same way, it is naturally conceivable also to construct the seat area 32 cylindrically. The second seat area 34 follows the first seat area 32 and is formed cylindrically.

During the seating/setting process of the self-piercing element 1, the second seat area 34 is expanded conically in order to anchor the self-piercing element 1 (see FIGS. 5 and 7). Due to this enlargement during the seating of the self-piercing element 1, a significantly improved axial fixing of the self-piercing element 1 in the structural component 5 is attained compared to the state of the art. In addition, the enlargement of the second seat area 24 leads to an increased radial clamping of the self-piercing element 1. This yields a rotation restraint, which is supported, for example, by a polygonal or non-round formation of the cutting geometry 20 in the top view. In connection with this, according to a preferred embodiment, the first seat area 32 extends over 30% and the second seat area 34 extends over 70% of the material thickness of the plastic component or structural component 5 at the joining location of the self-piercing element 1. Based on this dimensioning of the self-piercing element 1, a flush conclusion of the beaded cutting geometry 20 can be realized at the corresponding side of the structural component 5. Additionally, with a less exact dimensioning it is guaranteed that the cutting geometry 20, after the seating/setting process, extends only a negligible amount at the corresponding side of the structural component (approx. 0.5 mm).

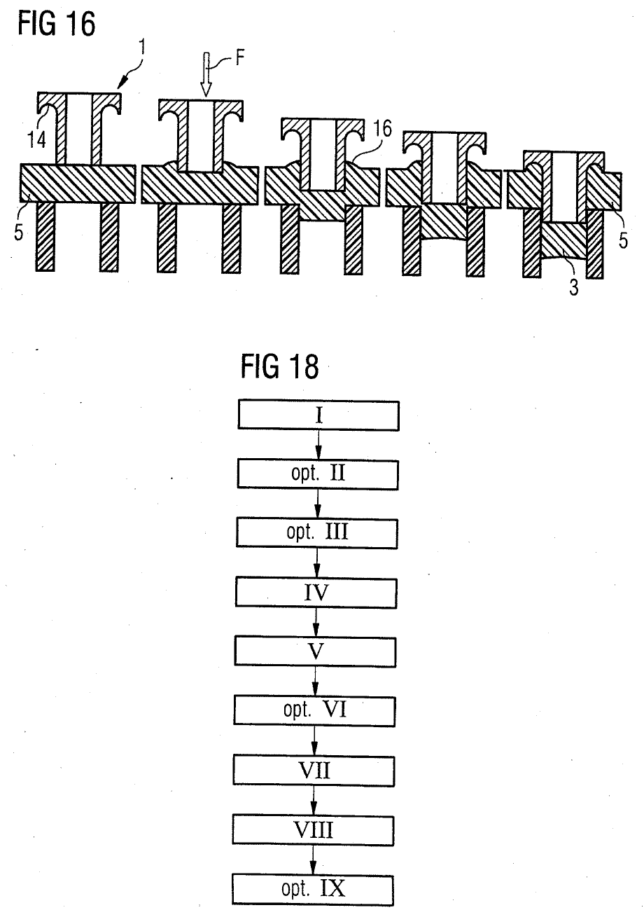

According to a further design, depending on the material of the plastic structural component 5, the functional head 10 is equipped on its side facing the structural component 5 with a radially circumferential groove 14 beneath the head (see FIG. 5). Especially during seating of the self-piercing element 1 in relatively soft plastic structural component 5, the groove 14 beneath the head receives a material build-up 16 during the seating of the self-piercing element 1. Using this construction, an optimal placement of the functional head 10 on the structural component 5 is supported. The function of the groove 14 beneath the head is exemplified schematically using FIG. 16. FIG. 16 shows different states that successively follow each other during the seating process of the self-piercing element 1 in a plastic structural component 5. While the self-piercing element 1 is pressed in the join direction F into the structural component 5, a material flow occurs counter to the join direction F. This material flow forms a material build-up 16 bordering on the seat geometry 30 of the self-piercing element 1. In order for the material accumulation 16 not to impede the placement of the functional head 10 on the structural component 5, the groove 14 beneath the head is dimensioned such that it receives the material build-up 16. This way it is guaranteed that the functional head 10 is optimally supported on the structural component 5.

According to a further embodiment, it is preferred to equip the functional head 10 on a side facing the cutting geometry 20 with a projecting contour 12 beneath the head. This contour 12 beneath the head guarantees a defined contact of the self-piercing element 1 on the structural component 5, and supports its firm fastening in this way.

An additional construction supporting the hold of the self-piercing element 1 in the structural component 5 arises from the FIGS. 19 to 23. A holding structure 36 is arranged on the radial outer side of the seat geometry 30. During the seating of the self-piercing element 1, this holding structure 36 anchors itself in the material of the structural component 5, and supports the hold of the self-piercing element 1 in the structural component 5. The holding structure 36 is composed of webs running parallel and/or perpendicular to the longitudinal axis L, while other orientations to the longitudinal axis L are also conceivable. In this way, the holding structure 36 forms an undercut against, for example, an axial displacement of the self-piercing element 1 within the structural component 5. For this purpose, the holding structure 36 includes profile angles which are formed depending on the material of the structural component 5. The profile angles preferably have a size of 60°±10° or 50°±20° with completely developed peaks of 70% to 100%.

In a further design, the seat geometry 30 includes on its radial exterior a seat area 38 offset radially inwards that forms a pocket for the material of the structural component 5 in the seat area 30. The inward offset seat area 38 permits the material of the structural component 5 during and after the seating process to flow relaxing into the pocket formed. In this way, mechanical stresses in the material are dissipated and the hold of the self-piercing element 1 is supported.

The constructions of the self-piercing element 1 described above are especially effective when the self-piercing element is placed in fiber reinforced plastics. With the help of these constructions, the anisotropies due to the fiber reinforcement and existing differences in the rigidities in the structural component 5 depending, for example, on the component temperature, can be overcome. In addition, with the geometries, described above, of the self-piercing element 1, it becomes apparent that in contrast to the joining of sheet metals, in particular the above features are necessary.

Suitable cold-form materials are used as a preferred material for the self-piercing element 1. They are resistant during seating of the self-piercing element 1, and prevent a cracking of the self-piercing element 1 in the beading area or in the second seat area 34, and the cutting geometry 20, which experience a strong deformation. Based on this material selection, during the clinching of the cutting geometry 20 and the second seat area 34, a crack-free ring shaped contact is attained with a simultaneous high rigidity of the cutting edge 26. This crack-free ring contact with the structural component 5 permits, for example, the transfer of high threading forces and, in addition, hinders the tendency of the plastic of the structural component 5 to relax.

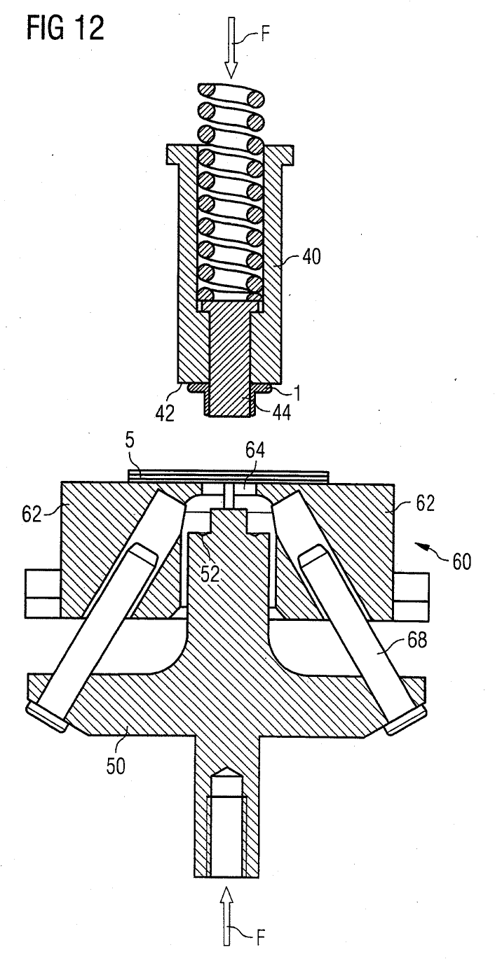

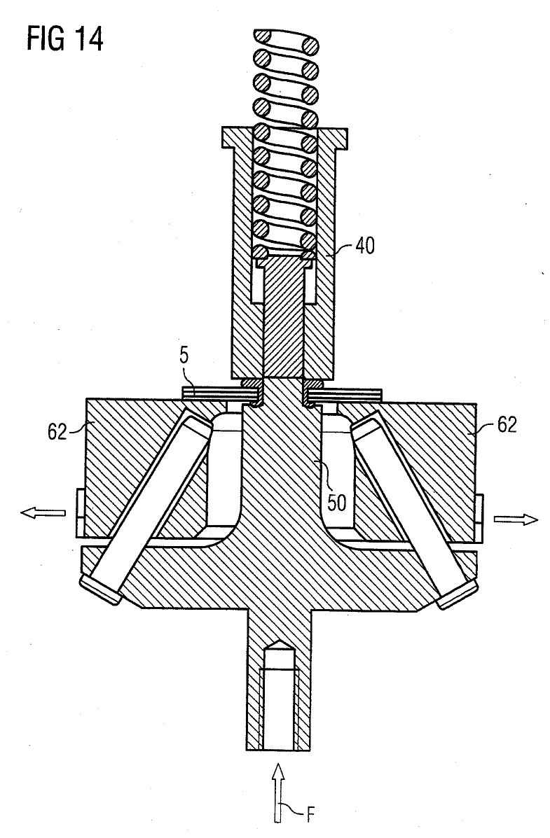

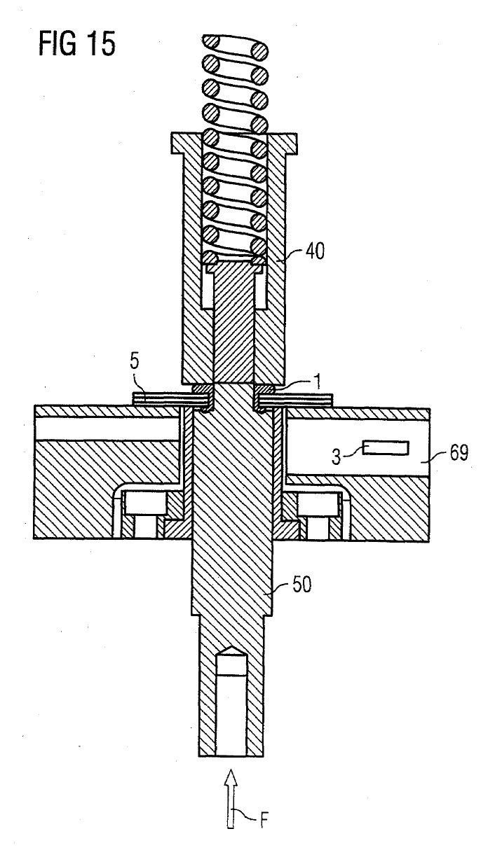

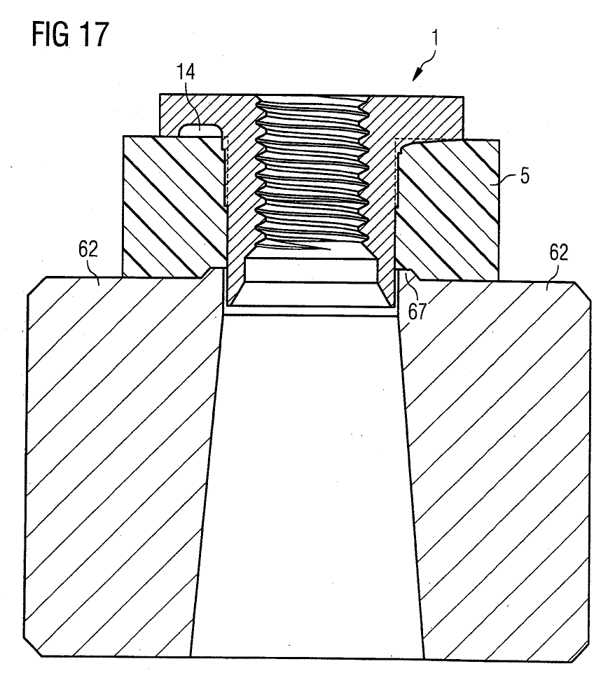

The self-punching element 1 is seated/set with an apparatus that is represented in the FIGS. 12 to 15. The FIGS. 12 to 15 show different stages of a seating method that according to a preferred embodiment of the invention arises from the flow diagram in FIG. 17. As shown in the FIGS. 12 to 15, the apparatus and the seating method are explained using the example of seating a self-piercing element 1 according to FIG. 1B.

The apparatus for setting the self-piercing element 1 is built as a self-contained tool. This permits use as a fixed assembly in a machine that performs additional processing on plastic structural component 5. A further alternative consists in using the apparatus as an attachment for mounting on an automatic handling device, for example, a multi-axis robot. In this context, it is also conceivable to use the apparatus as an attachment for mounting on a manual handling device, for example, a frame with cable guides.

Initially, the self-piercing element 1 according to step I (see FIG. 18) is positioned on a punching tool 40 (see FIG. 12). The positioning of the self-piercing element 1 occurs preferably by means of a conventional separation. However, it can occur also manually.

The punching tool 40 includes a receiving contour 42 with retainer for the self-piercing element 1. On the one hand, the receiving contour 42 transfers the axial joining force onto the self-piercing element 1. On the other hand, the receiving contour 42 serves as an opposing support for the clinching or beading of the cutting geometry 20 of the self-piercing element 1 by a clinch tool 50 (see below). In addition, the punching tool 40 has a spring-biased leading region 44 that works together with the clinch tool 50.

Before the seating/setting process, the structural component 5 is positioned on the die 60 (see step VI). The die 60 consists of at least two movable die segments 62. Between the die segments 62, an opening 64 is provided, into which the self-piercing element 1 engages during the seating process. Before the start of the seating process, an optional positioning of the die segments 62 occurs according to step II. Through the positioning of the die segments 62, a gap 66 between the inside of the opening 64 and the exterior of the self-piercing element 1 is adjusted in its width depending on the material of the structural component 5. For the adjusting of the gap width, it is also conceivable to consider the conditions of the seating process in order to optimally fasten the self-piercing element 1.

The gap width for a plastic such as GMT at room temperature, which is a more solid structure, (e.g., GMT GF40 at 20° C.), should lie in the range of 0.25 to 0.40 mm. With a plastic such as PP long fiber at an increased temperature, which is a viscous structure (e.g. PP GF30 at 60° C.), the gap width should be in the range of 0.0625 to 0.1155 mm.

The width of the gap 66 and the size of the opening 64 are realized by shifting the die segments 62 using cylinders or forcing guides 68.

According to a further optional step of the method, it is preferred to heat the structural component 5 composed of plastic at least in the area of the joint location of the self-piercing element 1. An equal result would be attained in that the structural component 5 is brought to the apparatus after its production before cooling completely, to start the seating process. The heated plastic of the structural component 5 facilitates the cutting in of the self-piercing element 1, and thus, the entire seating process.

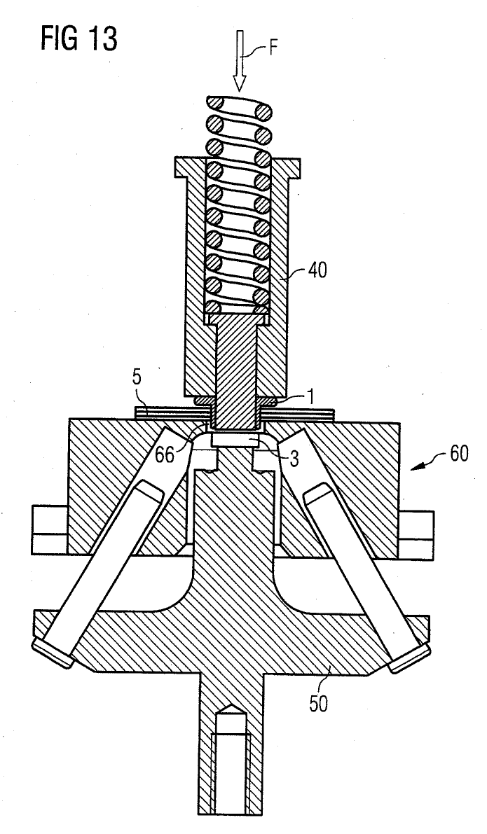

After the structural component 5 has been positioned accordingly on the die 60 (see step IV), the cutting of waste piece 3 out of the structural component 5 occurs by advancing the punching tool 40 in the join direction F (step V). FIGS. 12 and 13 represent how the self-piercing element 1 cuts the waste piece 3 out of the structural component 5 by advancing the punching tool 40. In FIG. 13, the waste piece 3 is already cut out, and the self-piercing element 1 is located in the opening 64 with the gap 66 between the adjacent die segments 62 and the self-piercing element 1. After completion of the punching or piercing process, the die segments 62 are slid radially outwards. If, for example, a die 60 with two to four die segments 62 is used, the die segments 62 are preferably moved over the forcing guides 68. These forcing guides 68 are coupled to the axial advancement movement of the clinch tool 50, so that during advancement of the clinch tool 50, the die segments 62 are moved away from the self-punching element 1. Thus, using the coupling between forcing guide 68 and the clinch tool 50, an active process regulation of the seating process is possible, but not necessary.

The clinch tool 50 includes a clinch contour 52 adapted to the cutting geometry 20 of the self-piercing element 1, where the cutting geometry 20 is deformed radially outwards with said clinch contour. After the waste piece 3 has been cut out by the self-piercing element 1, it is held by a support edge 54 and the closed die 60. Now, the removal of the die segments from the self-piercing element 1 can occur according to step VII, and the deforming of the cutting geometry 20 of the self-piercing element 1 can occur through the advancing of the clinch tool 50 to the structural component 5 according to step VIII. In order for the waste piece 3 not to cause a disruption during this process, it is removed via a suitable channel 69 in the die 60 (see step IX). The removal of the waste piece 3 occurs by a mechanically transmitted pulse or with the help of a media, for instance, air.

For deforming the cutting geometry 20 and the second seat area 34, the clinch contour 52, adapted thereto, clinches the corresponding area radially outwards. This way, a shape, running radially outward in a rounded form, of the cutting geometry 20 and the second seat area 34 is created within the structural component 5, as can be recognized in FIGS. 2, 3, 5, and 7. During this deformation by the clinch contour 52, it is especially preferred to attain a clinch or beading of the self-piercing element 1 that is flush with the surface. This guarantees that, for example, the structural component 5 can be fastened to a frame structure of a motor vehicle without an offset in height. Naturally, it is also conceivable to fasten the self-piercing element 1 in the structural component 5 with a small height offset.

To support the above mentioned surface-flush clinching of the self-piercing element 1, the die 60 is preferably equipped with a contour 67, adjacent to the opening 64, projecting in the direction of the punching tool 40 (see FIG. 17). During the seating procedure of the self-punching element 1 by the punching tool 40, this projecting contour 67 is impressed into the structural component 5, and in this way creates a depression in the structural component 5. The clinched or beaded end of the self-piercing element 1 can then “disappear” within this depression (not shown) despite the protrusion at the surface of the structural component, so that in this way, a clinch or beading is attained that is surface-flush relative to the underside of the structural component 5.

The radial opening of the die 60 occurs through the forcing guides 68, already mentioned above, which are arranged between the die segments 62 and the clinch tool 50. Because the die segments 62 are moved laterally away during the advancing movement of the clinch tool 50, a sufficiently large area is available that enables access for the adapted clinch contour 52 to the cutting geometry 20, and facilitates the clinching or beading.

According to a further alternative of the presented seating method, it is conceivable to heat the plastic structural component 5, at least in the area of the seating location of the self-piercing element 1 (see step III). Equally, it would be possible to convey the structural component 5, after its production before cooling completely, to the apparatus in order to facilitate the seating of the self-piercing element 1.

A feature of the seating process of the self-piercing element 1 is a radially fixed positioning of the self-punching element 1, the apparatus, and the structural component 5 relative to each other during the entire seating process. The advantage arising from this is the integration of the individual method steps without the necessity of respectively new positioning of self-punching element 1 and the structural component 5 between the process steps. This reduces the susceptibility to disruption of the method, and contributes to the optimization of the seating method.

We claim:

1. A self-piercing element that can be connected to a structural component, preferably of plastic, by means of piercing and beading, and has the following features:
a. a functional head arranged on one end of the element and coaxially to the longitudinal axis of the element,
b. a cutting geometry arranged coaxially to the longitudinal axis of the element, and a seat geometry arranged between the functional head and the cutting geometry, wherein
c. the cutting geometry includes a radially outwards arranged centering exterior bevel, a radially inwards arranged interior bevel, and a cutting edge arranged in between.

2. The self-piercing element according to claim 1, whose cutting geometry is provided rounded or polygonal.

3. The self-piercing element according to claim 1, whose cutting edge has a width of 0.15±0.1 mm.

4. The self-piercing element according to claim 1, whose exterior bevel extends over a length of 0.1-0.2 mm from the cutting edge, and is arranged at an angle of 10° to the longitudinal axis of the self-piercing element.

5. The self-piercing element according to claim 1, whose interior bevel is arranged in a first angle α≦45°, preferably 30° to 40°, to the longitudinal axis of the self-piercing element, or in a second angle of β≧60°, preferably in an angular range of 70° to 85° to the longitudinal axis of the self-piercing element.

6. The self-piercing element according to claim 1, which has a second exterior bevel that is arranged radially outward from the centering exterior bevel arranged at the outside.

7. The self-piercing element according to claim 1, whose seat geometry at its radial outside has a supporting holding structure and/or a radially inward offset seat area.

8. The self-piercing element according to claim 1, whose cutting geometry is adaptable in its length to a ring-shaped contact arising between element and structural component and/or to a permissible surface pressure of the structural component.

9. The self-piercing element according to claim 1, whose cutting edge runs along an outer surface of an imaginary cylinder, whose cylinder longitudinal axis is arranged perpendicularly to the longitudinal axis of the self-piercing element, such that a section of the cutting edge is offset relative to the remaining cutting edge in the direction of the longitudinal axis of the self-piercing element.

10. The self-piercing element according to claim 1, that has a support edge, with which a cut out waste piece can be caught, and a jamming of the waste piece in the self-piercing element can be prevented.

11. The self-piercing element according to one claim 1, whose seat geometry has a first and a second seat area, while the second seat area can be widened conically for fastening the self-piercing element.

12. The self-piercing element according to claim 11, whose first seat area is built cylindrically or conically, preferably with a cone angle of 5±0.5° relative to the longitudinal axis.

13. The self-piercing element according to claim 11, whose first seat area extends over 30%, and whose second seat area extends over 70% of the thickness of the structural component.

14. The self-piercing element according to claim 1, whose cutting geometry in the top view has a round, oval, elliptical or polygonal shape.

15. The self-piercing element according to claim 1, whose functional head on a side facing the cutting geometry has a projecting contour beneath the head that supports a defined contact of the self-piercing element on the structural component.

16. The self-piercing element according to claim 1, whose functional head on a side facing the cutting geometry has a groove beneath the head in which a material build-up can be received during setting of the self-piercing element, in order to support the contact of the functional head on the structural component.

17. A structural component, preferably a plastic component, that is equipped with at least one self-piercing element according to claim 1.

18. An apparatus, for setting a self-piercing element in a structural component, which has the following features:
a. a punching tool and a clinch tool, which are arranged opposing each other, and are movable parallel to their longitudinal axis in the join direction,
b. a die, built from at least two movably arranged segments, which defines an opening for the punching tool with self-piercing element, wherein
c. a position of the segments can be adjusted such that a gap between the inside of the opening and the outside of the self-piercing element can be adapted in its width depending on the material of the structural component and/or the conditions of the setting process, in order to optimally fasten the self-piercing element.

19. The apparatus according to claim 18, whose clinch tool has a clinch contour, adapted to a cutting geometry of the self-piercing element, with which the cutting geometry can be deformed radially outwards.

20. The apparatus according to claim 18, whose die on its side facing the punching tool is provided near the opening with a radially running and projecting contour, with which a depression can be generated in the structural component.

21. The apparatus according to claim 18, whose die has at least one channel, via which a waste piece can be led off.

22. A setting method for a self-piercing element in a structural component, preferably a plastic component, using an apparatus according to claim 18, that has the following steps:
a. positioning the self-piercing element with cutting geometry on the punching tool,
b. positioning the structural component on the die and cutting a waste piece out of the structural component by advancing the punching tool to the structural component, and
c. removal of the segments of the die from the self-piercing element and deforming the cutting geometry of self-piercing element by advancing the clinch tool to the structural component.

23. The setting method according to claim 22, that has the further step:
positioning of the segments of die such that a gap between the inside of the opening and the exterior of the self-piercing element can be adapted in its width depending on the material of the structural component and/or the conditions of the seating process, in order to optimally fasten the self-piercing element.

24. The setting method according to claim 22, that has the further step:
heating of the plastic structural component at least in the area of the seating location of self-piercing element or feeding the plastic structural component after its production, and before cooling completely, to the apparatus, in order to facilitate the seating of the self-piercing element.

25. The setting method according to claim 22, that has the further step:
during the cutting of a waste piece out of the structural component, introducing a depression in the structural component adjacent to the cutting geometry of the self-piercing element.

26. The setting method according to claim 22, that has the further step:
after cutting a waste piece out of the structural component, leading the waste piece away via at least one channel in the die.
